(19) United States
(12) Patent Application Publication
(10) Pub. No.: US 2014/0297635 A1
(43) Pub. Date: Oct. 2, 2014

(54) INTERFACE FOR MANAGING PERSONAL DATA

(71) Applicant: ADT US Holdings, Inc., Boca Raton, FL (US)

(72) Inventors: Arthur Orduna, Delray Beach, FL (US); Joy Wald, Parkland, FL (US); Tana BartonHaas, Ocean Ridge, FL (US); Scott Johnson, Boca Raton, FL (US)

(73) Assignee: ADT US Holdings, Inc., Boca Raton, FL (US)

(21) Appl. No.: 14/187,977

(22) Filed: Feb. 24, 2014

Related U.S. Application Data
(60) Provisional application No. 61/768,043, filed on Feb. 22, 2013.

(51) Int. Cl. G06F 17/30

(52) U.S. Cl. CPC G06F 17/30696
USPC 707/736

(57) ABSTRACT

The invention relates to a system that collects personal data for a user from a plurality of information sources, wherein the personal data includes event data from a security system; analyzes the personal data to generate insight data about the user; and presents the insight data to the user in a format that is contextually relevant to them. The system may also be configured to enable a user to share certain data with other users, who can socialize on the user's data, which the system may analyze to generate further insight data about the user. The system may provide recommended actions, activities the user may participate in, or things that the user may acquire in order to become more efficient in their daily routines, enhance wellness, or improving toward certain goals.

### CROSS-REFERENCE TO RELATED APPLICATIONS

This application is related to and claims priority to U.S. Provisional Application Ser. No. 61/768.043, filed Feb. 22, 2013, entitled “SYSTEM FOR ANALYZING AND MANAGING PERSONAL DATA,” the entirety of which is incorporated herein by reference.

### BACKGROUND

The invention relates to a system for analyzing and managing personal data, particularly to a system that enables a user to collect, view, and control the use of their personal data; and to broker that data by receiving value from a third party in exchange for allowing the third party to use that personal data.

The desire to be safe and secure—as to oneself, one's family and friends, and one's property (physical or “digital”)—is fundamental. With the advent of the telegraph and telephone in the 1800's, technology allowed for the remote monitoring of a home and dramatic improvements in safety and security. As technology has improved over the years—such as with the creation of digital communications, cellular and other wireless, broadband and the Internet—so has the ability of this technology to improve security.

At the same time, these changes in technology have made personal protection more complex. People are physically more mobile today, are in their homes less, and are moving from one home to another more often. More activities are taking place outside the home, separate from one another, via mobile devices. A person's identity, behaviors, situation, and other personal information, are becoming more and more valuable to them. Not only does this personal data need to be secure, but it can also be used to provide important insights into the health and security of individuals and their families—helping them to be more safe and secure. However, existing systems do not readily allow for an individual to fully manage and gain such insights.

Security and other systems traditionally are not “smart.” They produce a limited amount of “raw” personal data about the user and events that have occurred, but they are not capable of analyzing this data to create insights about a user or to anticipate the user's needs. They are also not capable of incorporating broader types of personal data to create these insights, such as biometric information, photos, videos, lists of personal assets, characteristics, usage information, behaviors, browsing history, etc. Such personal data can be created by individuals themselves (such as in profiles on social media or various smart phone applications); captured by others (such as Web site data or location data when using mobile devices), or data about people crafted from analysis of offered and/or captured data (such as credit scores and other data gathering services). All of this data could provide beneficial insights that can be used by the user to better anticipate the user's needs.

Moreover, the world's growing complexity is accelerating the need to better understand, manage and protect our physical and digital assets. While the world is increasingly connected, digital, and individually addressable, people's lives remain physical, tangible, immediate and highly personal. A person's personal assets are precious—beginning with their own well-being and safety, growing more voluminous and valuable as they and their loved ones move through the stages of their lives. An individual's digital data holds powerful potential value both for them and for others—but it is impossible for the average consumer to easily access and view, let alone to understand and effectively manage, all their rich, dynamic and varied personal data.

There is also currently no simple way for individual's to manage their physical and digital worlds, but the need is there, and, to date, there has not been an acceptable solution to this problem. Prior solutions are fragmented—either traditional protection of the physical or incomplete management of the digital. The landscape is confusing—no single experience or interface exists across all screens and platforms. Personal data is created literally every second, but there is no easy way to access, understand, or derive benefit from it in a complete way because it exists in silos.

But the need is real and rising. People should be able to create, manage, control, exchange, and monetize their personal data just like any other personal property. It's not just the threat of theft or damage to an individual's digital and physical assets, but also lost opportunities from the unauthorized and unknown usage of that person's digital identity (their valuable personal data). Moreover, huge industries, from digital content to retail to advertising, need an individual's data to grow their businesses, which they're finding more and more ways to do, all without the individual's knowledge or benefit.

What is needed is a holistic solution that can enable an individual to effectively and efficiently manage their broad range of personal data. Such a solution can leverage multiple technologies. For example, broadband networks have enabled “cloud everywhere” accessibility. Addressable app-rich IP devices are commonplace and accessible by most. Consumer data is richer, broader, and more valuable than ever before. There are more tools and services enabling individuals—and others—to monitor and manage a person's home and workplace. Individuals are increasingly comfortable living off-line and “on-line.”

### SUMMARY OF THE INVENTION

The invention relates to a system to collect personal data for a user from a plurality of information sources, wherein the personal data includes event data from a security system; to analyze the personal data to generate insight data about the user; and to present at least a portion of the insight data to the user in a format that is contextually relevant to the user. The insight data may be based, for example, upon combination of different types of personal user data, other data, predetermined system criteria, behavioral data generated by the system based on an analysis of the user's actions (including in response to being presented their insight data or personal data or such data about populations of others in the system), and/or user determined criteria. The invention is capable of generating insight data by analyzing a mixture of different formats of personal data, such as video data analyzed along with text.

The insight data about the user may include a user (or system) defined scoring of different types of personal data that enables the user to track how they are doing against certain goals, or how they compare to other users—it may be an absolute or a relative score. The scoring may be based on one type of personal data, multiple types, or a more comprehensive “life” score based on a larger collection of types of personal data about the user.

The system may also be configured to enable a user to share certain personal data (and insight data) with other users within the system. Other users within the system can socialize on the user's data and the system may analyze the results of this socialization to generate further insight data about the user (and/or the other users who participated).

The system may further be configured to help educate the user about the user's personal data, insight data, and behavioral data (and/or such data from others in the system), such as by providing recommended actions the user may take, activities the user may participate in, or things that the user may acquire in order to, for example, become more efficient in their daily routines, or enhance wellness in various areas (physical, financial, etc.), or improving their scoring toward certain goals or provide recommendations for local activities or establishments.

### BRIEF DESCRIPTION OF THE DRAWINGS

For a better understanding of various embodiments of the invention, reference should be made to the following detailed description which should be read in conjunction with the following figures wherein like numerals represent like parts.

FIG. 1 is an illustration of a system employing the invention.

FIG. 2 is an example of data modeling/flow in accordance with the invention.

FIGS. 3(a)-(q) are pictures illustrating examples of the operation of a system employing the invention.

### DETAILED DESCRIPTION

For simplicity and ease of explanation, the invention will be described herein in connection with various embodiments thereof. Those skilled in the art will recognize, however, that the features and advantages of the invention may be implemented in a variety of configurations. It is to be understood, therefore, that the embodiments described herein are presented by way of illustration, not of limitation.

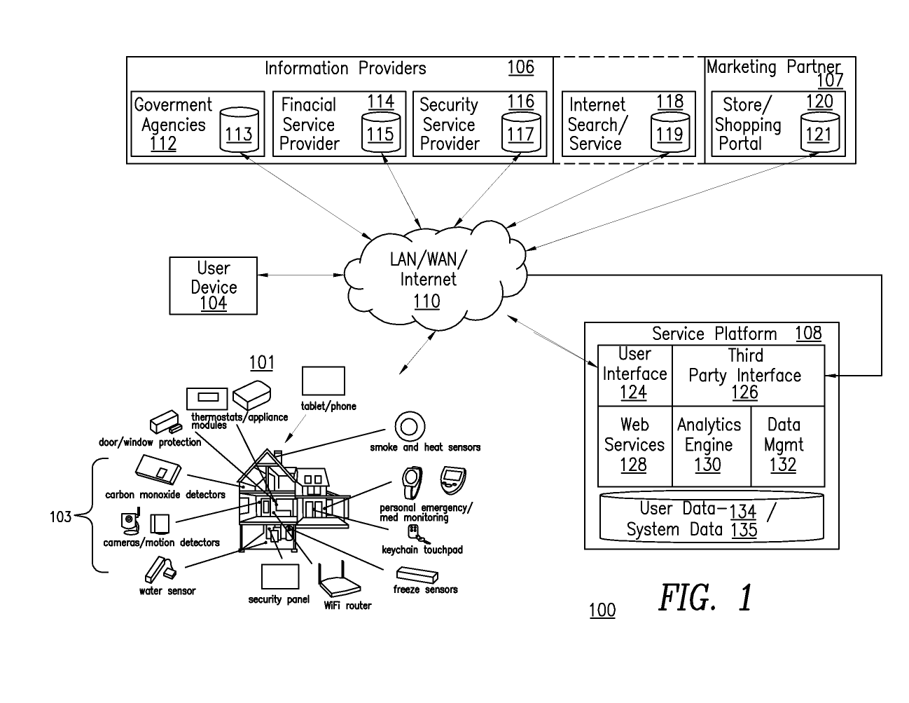

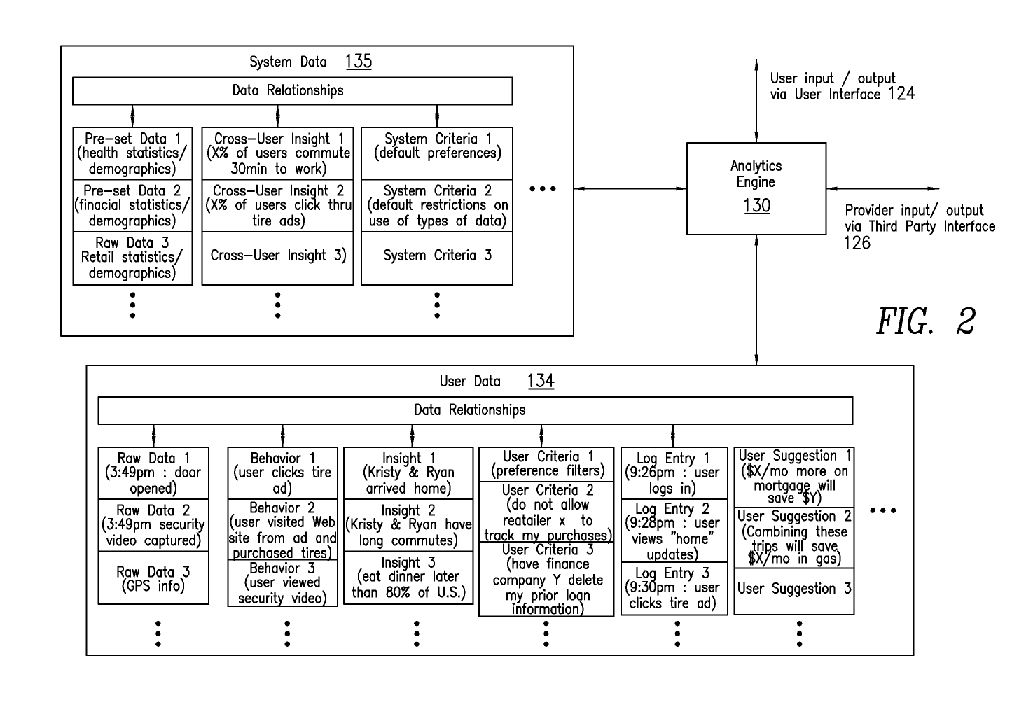

FIG. 1 will be used to illustrate various aspects of a system employing the invention. As shown in FIG. 1, in system 100 one or more users 102 may provide information to, and receive information from, one or more Information Providers 106 and a Service Platform 108 via communication network 110, using one or more user devices 104.

Information providers 106 may be third parties service providers that gather various types of personal data from user 102 in the course of providing a service. For example, information providers 106 may be a government agency 112 (such as a state department of motor vehicles) that may store identity or other such “raw” data about the user in a data source 113, a financial service provider 114 (such as a bank) that may store financial information about the user in a data source 115, or a security service provider 116 (such as a home security & automation monitoring service) that may store data from devices monitored at a premises system 105 in a data source 117.

Such a security system 105, as shown in FIG. 1, may include a control panel/gateway 101 for monitoring and/or controlling devices 103 at a home or other location over a local network. Portions or the entirety of the network maybe wireless. Such devices 103 may detect and/or control door and window openings and closings, detect alarm conditions, notify people within an area about alarm conditions, track and/or control temperature, or accomplish a variety of premises related other functions that may be desired. For example one or more motion detectors may be used to sense motion. Other detectors other alarm conditions, such as glass breaking, fire, smoke, temperature, chemical compositions, water, carbon monoxide, or other hazardous conditions. Video cameras may be used to detect motion and/or capture video of events. When an alarm condition or other event is sensed, control panel 101 may transmit an event signal to one or more notification devices, such as annunciators (e.g., horns and/or strobes, for example) or a local tablet or similar user device, and/or user device 104. Heating, ventilation and air-conditioning (HVAC) controls, thermostats, remotely controllable appliance switches, wall switches, receptacles, and other home automation devices may also be used. Such premises systems may be used within a boat or other vehicle, office suite, industrial building, residence and the like. It should be understood that not all of such devices may be installed within a given system.

Those of ordinary still in the art will appreciate that these are just examples, and the invention may be used with any type of personal data about the user (and family, friends, pets, etc. to the extent information about them is also included in the user's personal data). The respective data sources of information providers 106 may comprise known hardware, software and data architectures, such as relational databases, Web servers, etc.

Functionally, service platform 108 may include a user interface 124 for communicating with user(s) 102, and third party interface 126 for communicating with the respective data sources of each of information providers 106; data management tools 132 for managing the exchange of personal data about the user among the respective data sources of information providers 106, user data source 134, and user device(s) 104.

User interface 124 may comprise, for example, any combination of technologies capable of connecting the user with service Platform 108 and enabling the functionality described herein, such as an application operating on user device(s) 104, a broadband network gateway device on the user's home network or on a remote network (such as the aforementioned security gateway 101), etc. Third party interface 126 may comprise, for example, application program interfaces (“API's”) and similar software for facilitating the transmission (and understanding) of data between service platform 108 and the data sources of the respective information providers. Similarly, the remaining functionality and components of service platform 108 and the invention generally may comprise integrated or separate hardware, software, data architectures, and other devices known in the art that can achieve the functionality described herein.

Communication network 110 may be any combination of network systems well known to those of skill in the art, including the Internet, a home Wi-Fi network, a cellular data network, etc. User device(s) 104 may be any device capable of communicating over such networks, such as a smart phone, tablet, personal computer, etc.

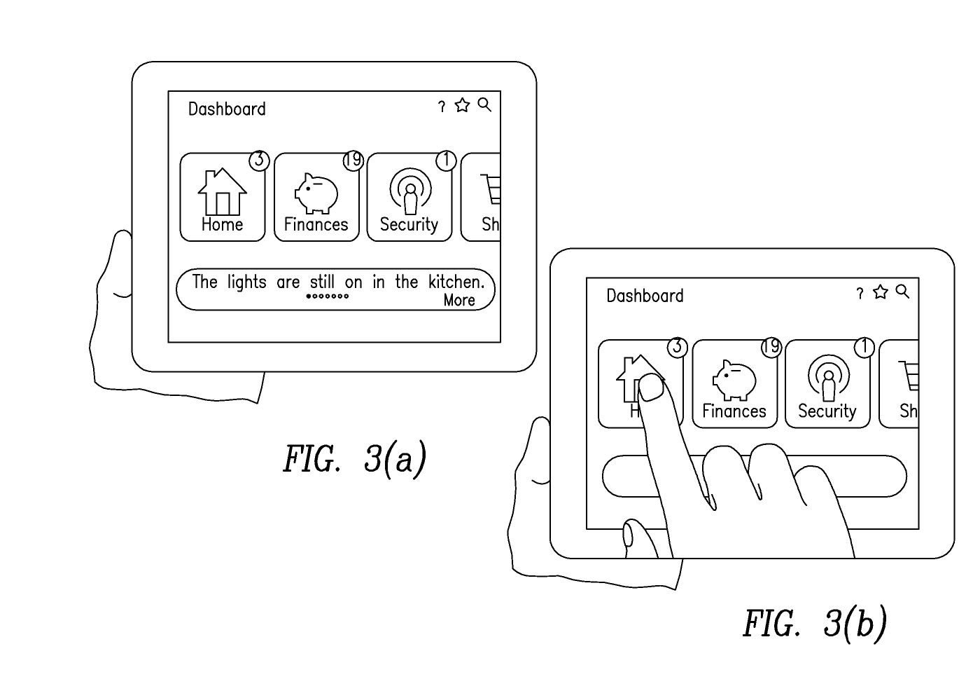

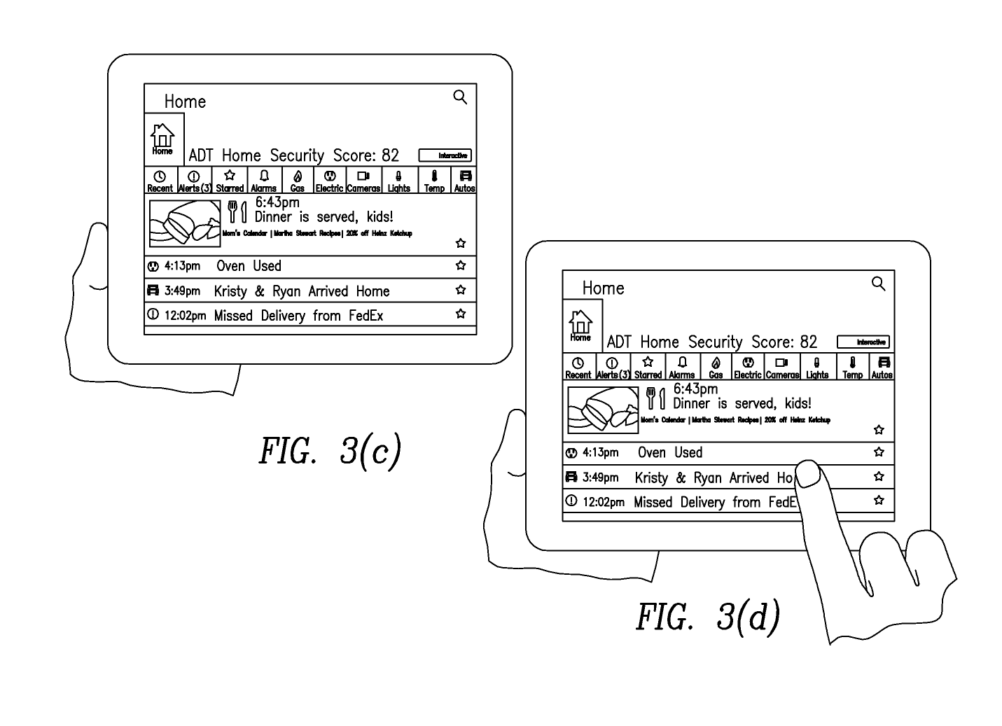

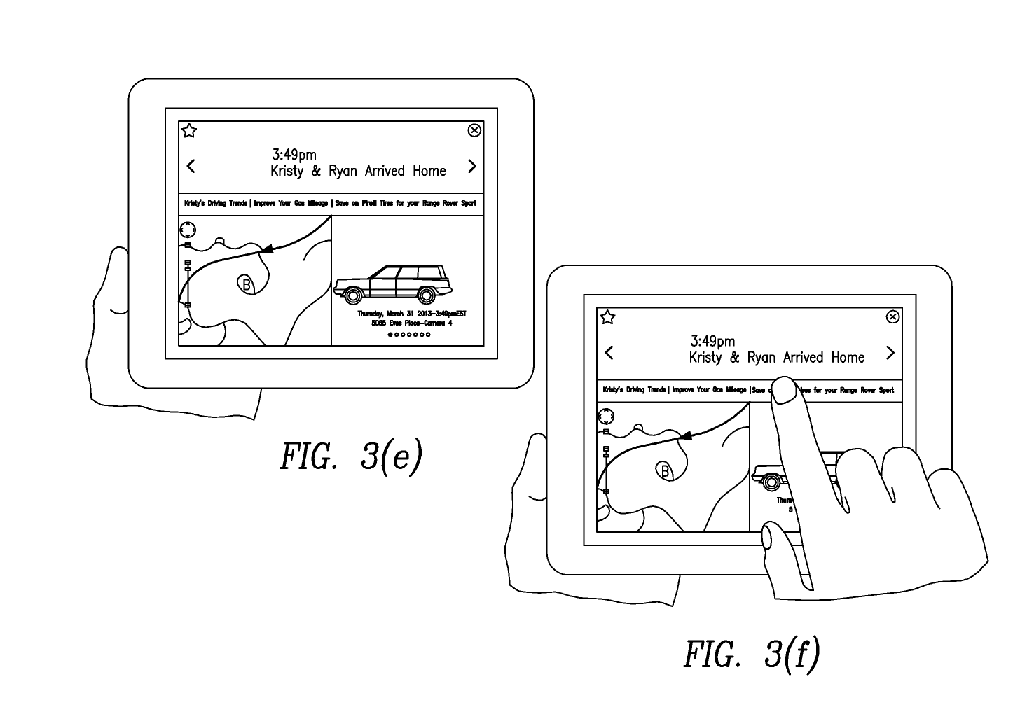

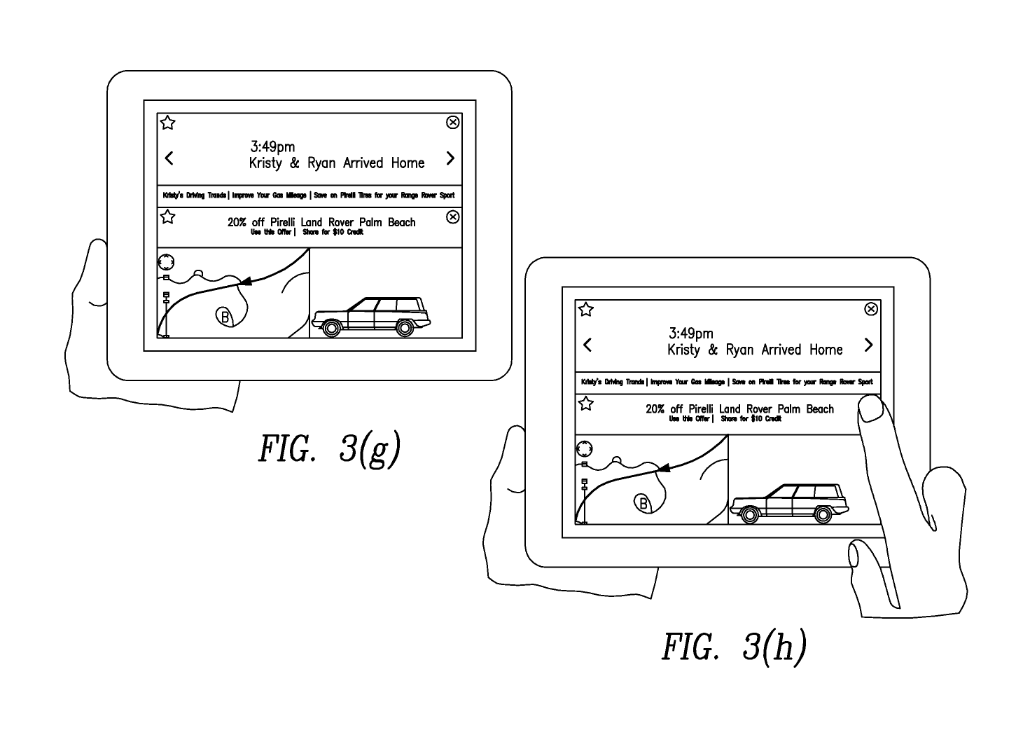

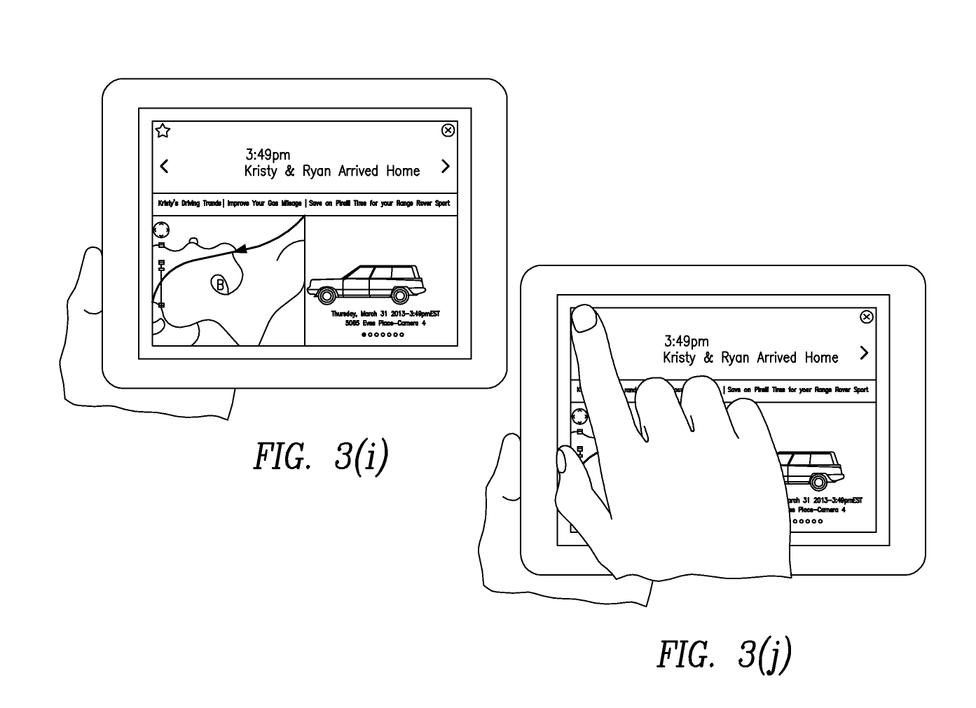

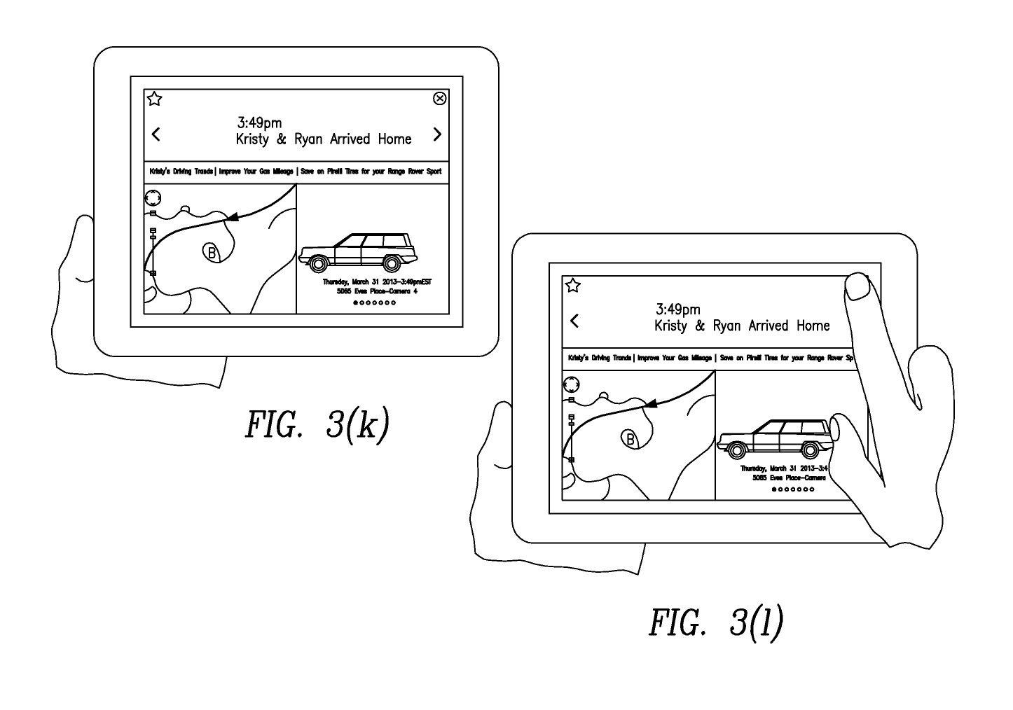

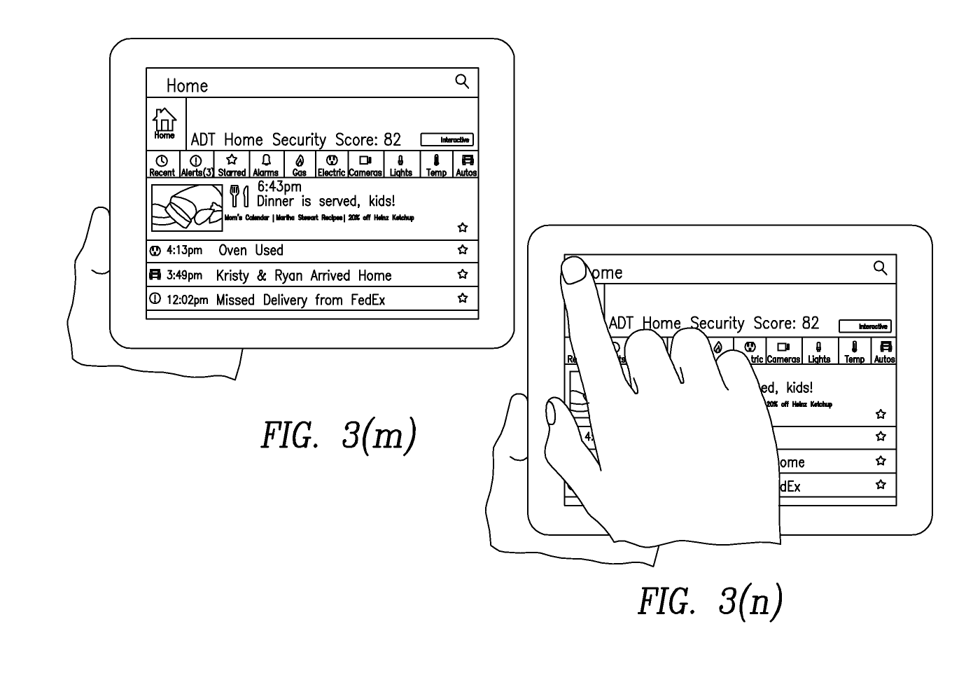

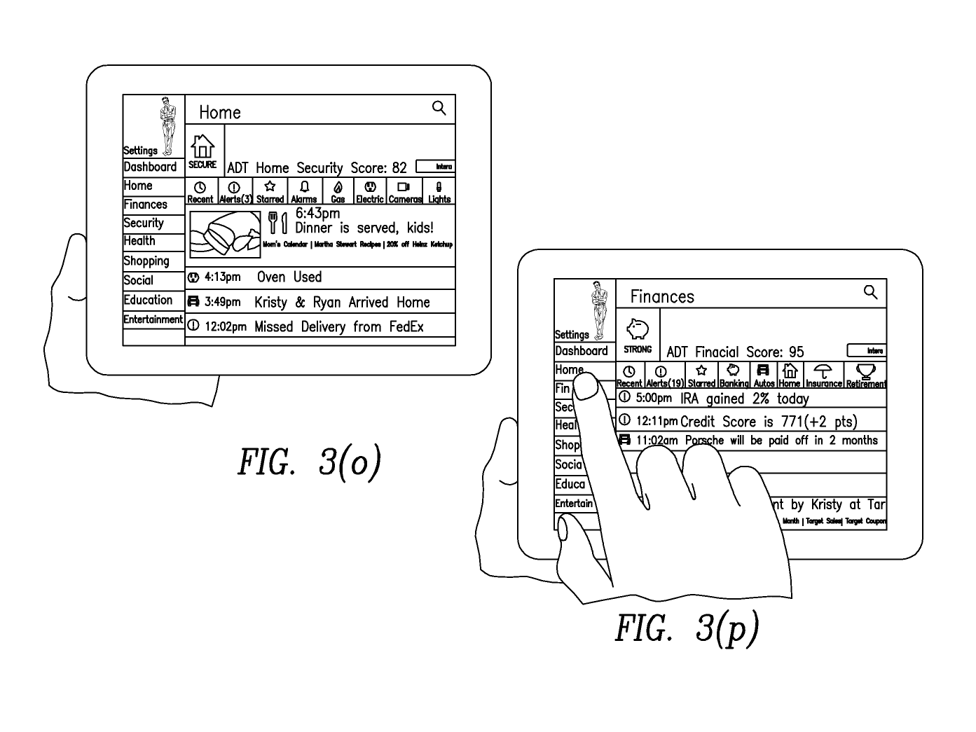

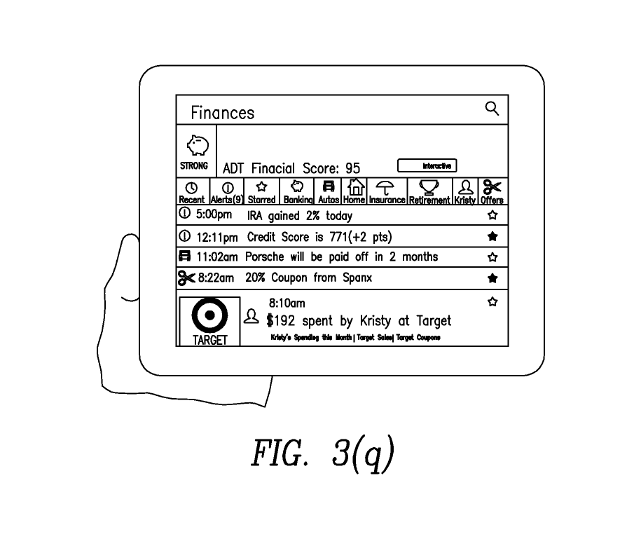

An illustration of how the system of the invention may operate is shown in FIGS. 3(a)-(q). In the example shown in the figures, user device 104 includes a tablet device and user interface 124 includes an application operating on the tablet. User interface 124 presents user 102 with an elegant, intuitive “dashboard” that enables the user to securely manage his/her physical digital life and assets as described herein. In this example, the tablet interfaces via the user's local area network and the Internet to a Web server that forms part of Service Platform 108.

When user 102 selects the “home” icon,” the application operating on user device 104 obtains (or refreshes) data about the user via communication network 110 (perhaps through a network gateway—not shown). Portions of this personal data may be stored in a centralized user data source 134, separately in the respective data sources of Information Providers 106, locally in the user device 104, and/or in some combination thereof. System data that is not specific to one user may also be stored in system data source 135. Web services 128 and data management tools 132 coordinate the assembly and transmission of this user data to user device 104.

In this way, the system provides the user with a high level of awareness of his/her personal information. By connecting various data points, such as home automation and social calendars, the system can give the user a holistic view of their life. The system can pull a user's data for them, be it financial, social or home and can put it all in one secure, manageable, and easy to access interface.

In addition to the user's personal data obtained from Information Providers 106 (or entered by the user herself), the system may also present users with additional data that provides them with insights about what their personal data may mean to them so that the user's data is provided to him/her in a format that is contextually relevant to him/her—and more than just an assemblage of raw information—which enables the user to make better use of the information. This insight data may be stored in the various locations noted above may be produced by analytics software forming part of analytics engine 130.

In operation, various types of information may be inputted (in ways well known to those of skill in the art) into an algorithm within software operating on a processor within analytics engine 130. This algorithm takes this inputted information and produces outputted insight data for the user. This insight data may be stored via data management 132 and may be further processed and/or filtered by analytics engine 130 to be provided to the user through user interface 124.

Actions taken by (or inputted by) the user using user interface 124 (or otherwise collected from an information provider 106), particularly those based on the data presented to the user, may be collected in service platform 108 as personal data that is behavioral data about the user. Analysis of these actions by analytics engine 130 may also be captured as behavioral data (and stored, for example, in user data 134).

The information inputted into analytics engine 130 for generating insight data may include, for example, a combination of different types of personal user data, predetermined system criteria, behavioral data for the user, user determined criteria, and/or other types of data. The invention is capable of inputting a mixture of different formats of personal data into analytics engine 110, such as video data analyzed along with text, and analyzing this data to output the insight data. Analytics engine 130 can use video analytics (e.g., facial recognition, motion detection/boundary conditions, object tracking, etc.) to draw information from video to be used in generating insight and behavioral data—such analyzing video of the user, and/or family, friends, pets, etc. to generate insight data.

In one example, as shown in FIG. 3(c)-(m), the user may be provided with insight data regarding security information (such as “Kristy & Ryan Arrived Home”) that is based on a mixture of personal data (such as an event record from security system that a door was opened, and perhaps video of the event with or without facial or other biometric identification), other data (such as GPS information on the location of Kristy & Ryan). The security information in this example may be provided a format that is contextually relevant to the user (such as showing what is happening with the family, and that they are safe and secure).

FIG. 2 includes an example just to illustrate how data might be modeled in accordance with the invention. As shown in FIG. 2 and discussed elsewhere herein, various forms of user data may be stored as User Data 134. This may include, for example, raw personal data such as received via information providers 106), behavioral data about the user (such as generated by their use of system 100), user criteria (such as may be submitted by the user via user interface 124), and log entries generated by the system. It may also include insight data and user suggestions generated by analytics engine 130. As also discussed elsewhere herein, the system may also store system data 135, which might include, for example, pre-set statistical and demographic data for various subject areas, such as health, finance, retail, etc. It might include pre-determined system criteria for how to process, store and/or analyze user data (such as default criteria in the absence of criteria specified by the user).

Analytics Engine 130 may input any of the aforementioned user data and system data, as well as input from the user via user interface 124 (or from an information provider 107), and process this information together to generate additional insight data and/or user suggestion data. This may be accomplished using data logic algorithms, statistical analysis, data analytics, and data manipulation in a manner known to those of ordinary skill in the art. This may include, for example, conventional software based statistical analysis functions, financial functions, time-series functions, text string functions, grouping functions, etc. It could also incorporate software based audio and video analytics capability (and the re-introduction of data outputted from such analytics back into the aforementioned functions). It may also include software based interactive, multi-user variations of these and other tools, as are being applied to “big data” (e.g., combining conventional analysis tools with querying among users to iterate through the analysis of large, disparate sources of data).

Some data analysis techniques that might be employed also include A/B testing, association rule learning, classification, cluster analysis, crowdsourcing, data fusion and integration, ensemble learning, genetic algorithms, machine learning, natural language processing, neural networks, pattern recognition, anomaly detection, predictive modeling, regression, sentiment analysis, signal processing, supervised and unsupervised learning, simulation, time series analysis and visualization. Multidimensional big data can also be represented as tensors, which can be more efficiently handled by tensor-based computation, such as multi-linear subspace learning.

Additional technologies also being used with big data that may be used in the invention include massively parallel-processing (MPP) databases, search-based applications, data-mining grids, distributed file systems, distributed databases, cloud based infrastructure (applications, storage and computing resources) and the Internet. This can be accomplished, of course, in various combinations of architectures, single or multiple processors, single or multiple server, single or multiple database, etc.

Generated data specific to the user may be outputted back to user data 134, user interface 124, and/or third party interface 126 (as determined, in part, based on user and system criteria). Data that relates to multiple users may similarly be outputted to system data 135 user interface 124, and/or third party interface 126.

The system may be used to create insight data that incorporates “scoring” related to an analysis of various types of personal data to enable the user to track how they are doing in relation to personal goals that they have established, or in relation to other users.

In the examples in the figures, the user has a “Home Security Score” of “82.” Analytics engine 130 may use algorithms that take user defined for predefined) criteria and apply them against the current security related personal data for the user provided by security service provider 116 to create this security score. These criteria could include comparing against similar scoring across a pool of other users, or against goals specifically set by the user as to the “level” of security that they would like to achieve.

By selecting “Finance” front the menu, the user can view his/her personal financial data that has been collected together from various financial service providers 114. In this example, this includes data from a financial advisor, a credit agency, and bank/credit card service. As with the security score, the system can create scores for other types of personal data, such as the “Financial Score” of “95” also shown in the figures. This financial score could be, for example, reflective of goals that the user has set in regard to their savings and investment toward retirement, or a relative comparison of the user's data against others fitting a determined demographic profile.

Those of skill in the art will appreciate that the system may also create “scoring” that is a combination of different types of personal data, or combinations of scoring for different types of data—for example, and omnibus score (e.g., a “life score”) that is a combination of a significant number of the different scores tracked by the system.

As shown in FIG. 1, a system employing the invention may also include one or marketing partners 107, such as an Internet service 118 (e.g., a search engine or Web portal)—that may also be an information provider 106, collecting the user's search history or other Web browsing information in data source 119—or an online store 120 (such as particular retailer or shopping site). The example of Internet service 118 being both a marketing partner and an information provider is represented in FIG. 1(b) by Internet service 118 being enclosed by dashes. Those of ordinary skill in the art will appreciate that marketing partner could also be an information provider, and vice versa. For example, online store 120 could also collect information on purchases made by the user in data source 121,

In the illustrated example of FIGS. 3(a)-(q), sonic of the user's personal data is information gathered by security devices at the user's home as provided by security service provider 116 (such as data from intelligent sensor devices in the home) combined with GPS data, perhaps from smart phone or cellular provider. An analytics engine 130 may analyze this personal data, alone or with other personal data about the user, and, based on this analysis, provide additional information to the user that is relevant to both the user and to a marketing partner 107—in this case presenting an advertisement for new tires that would be relevant to store 120. Those of ordinary skill in the art will appreciate that marketing partner 107 can be any type of organization that would have interest in the user's, and is not limited to advertisers, retailers, etc. The advertisement may be static or may be interactive, for example, including links to additional information or actions the user can take, or containing video and other similar types of materials. The advertisement may be selected by analytics engine 130 from a cache of advertisements (stored with user data 134 or in marketing partner data source 121) created by marketing partner 107, or could be created/modified by analytics engine 130 based on the user's personal data, insight, data, and/or behavioral data.

Any actions that the user takes in regard to this advertisement can also be stored as personal/behavioral data, and may be provided back to the information partner. For example, if the user “clicks” on this advertisement and is presented additional information or visits the advertiser's Web site, this can information can be tracked in the system and provided to store 120. Behavioral data can also be generated, for example from information can also be entered by the user by indicating that they “like” or “dislike” certain content, which itself may also be used by analytics engine 130 to generate insight data.

However, unlike conventional data mining applications, a system employing the invention may also be used to advocate on behalf of the user and as a brokering system. In accordance with the invention, the system allows for the user to “opt in” to the use of certain of their personal data, and/or the receipt of targeted advertisements on user interface 124, in exchange for receiving rewards or other value from the respective information providers 106 and/or marketing partners 107.

For example, in the illustrated example, the user may allow a store 120 (such as the retailer in this example) to track the user's purchasing and spending (and perhaps to provide targeted advertising) in exchange for receiving coupons/discounts, credits or “cash” to a digital wallet or other rewards back, directly or indirectly, from the marketing partner.

The reward may be tangible or intangible. The reward may also be based on one or more types of personal data, the insight data, the user's behavioral data (such as the user's actions in response to targeted advertising), and/or the user's interests.

As discussed above, the invention thus provides for a system and related processes that serve as a data broker for user of the system. Users may sign up to be members of a community within the system; for example by joining via a basic mobile device application. Member may pay for additional services/products with opportunity for discount or offset by breadth/richness of data allowed to be marketed by the system (Addressable Profiles composed of Consumer's data).

The invention connects and manages an addressable market for marketing partners (or other third parties) wanting to target very specific clusters, households and individuals with digital products/services/ads, and establishes relationships with third parties for Addressable Digital Transactions (ADT's). Using the invention, a partner may send targeted p/s/a to the system. The system presents this p/s/a to member on their mobile/IP devices. The member interacts as appropriate—and the system can return fulfillment and measurement data to the third party, who sends a digital “reward” (discounts, coupons, digital content, e-currency) for member to the system where it may be stored in the member's Digital Bank (e.g., user data 134).

These advocacy aspects of the invention provide significant advantages over the prior art. The invention provides a mutually beneficial, growing relationship, not just a business exchange. It allows for the arbitration and generation of value and revenue for the user across information providers and marketing partners, instead of the user being obligated to provide his/her personal data for free in exchange for receiving a service from each information provider/marketing partner. It also allows for the user to gain insights based on individual context and data to enable time savings and improved quality of life, as well as to control and personally benefit from his/her own personal data.

A system employing the invention provides a user with a high degree of control and privacy over the use of his/her data. The system allows users to indicate that they wish to block selected personal data from being used by one or more information providers 106, and to have this personal data deleted from the respective data sources. Similarly, if the user no longer wishes to have a marketing partner track his/her personal data, the user would have the ability, through the system, to “opt out”—at which point the marketing partner would be blocked from gathering (or at least using) additional personal data of the user, and perhaps to delete some or all existing data. Those of ordinary skill will also appreciate that instead of an absolute “opt-in”/“opt-out”, the user (via the system of the invention) may allow for use of his/her personal data. (raw data, insight data and behavioral data) or some portions thereof based on certain terms and conditions.

The control and privacy aspects of the invention provide significant advantages over the prior art. The invention provides transparency to a user on what personal data is used and control over when—a user effectively has a “stop” button for everything and can disable usage tracking. It provides the ability to erase personal data (including photos and video) permanently across all records of different information providers/marketing partners through a common platform. The invention also enables easy migration of data—the user owns his/her data and can move it easily across information providers and within service platform 108. The user can safely accessed and control this personal data on any Internet connected device with a simple yet secure, one-click log-in.

A system employing the invention also enables a user to privately and securely share certain of their personal data. (e.g., not just photos and video, but other personal data about their activities and personal life, where they've been, their health, etc.) with family and friends, who are also users with access to system 100, in particular service platform 108. User interface 124 enables each user to designate certain personal data to be share and with whom it may be shared within the system.

Other users within the system can socialize on the user's data (when permitted by that user) and the system may analyze the results of this socialization to generate further insight data about the user (and/or the other users who participated). For example, other users may provide comments to the user, or provide personal data about themselves not already captured in the system. The other users may themselves take some action (e.g., uploading pictures, visiting a marketing partner noted in the first user's data, etc.) based on the first user's data, thus creating their own behavioral data that can also be stored as insight data in regard to the first user, perhaps in conjunction with the personal relationship between the users as a friend, or family member. The resulting personal data could be analyzed by the system in connection with any of the users.

This community aspect of the invention provides additional significant benefits over the prior art. The invention allows for privately connecting members with family and friends to enable information sharing and overall enhanced life and activity coordination; and creates a community of fellow users who share insights into how to leverage the solution to enhance and improve their lives.

The system may further be configured to help educate the user about the user's personal data, insight data, and behavioral data (and/or such data from others in the system that they care about—family, friends, even pets), such as by providing recommended actions the user may take, activities the user may participate in, or things that the user may acquire in order to, for example, become more efficient in their daily routines, or enhance wellness in various areas (physical, financial, etc.), or improving their scoring toward certain goals. Such digital footprint mapping and educational tools allow members to see where and how their data is used.

It is to be understood that variations and modifications of the various embodiments of the invention can be made without departing from the scope of the invention. It is also to be understood that the scope of the invention is not to be interpreted as limited to the specific embodiments disclosed, herein, but only in accordance with the appended claims when read in light of the forgoing disclosure.

1. A method for managing personal data of a user comprising the steps of:
collecting personal data for the user from a plurality of information sources, wherein the personal data includes event data from a security system;
analyzing the personal data, including at least a portion of the event data from the security system, to generate insight data; and
presenting at least a portion of the insight data to the user through a user interface in a format that is contextually relevant to the user.

2. The method of claim 1, wherein the analyzing is accomplished using one or more selected from the group consisting of raw data about the user, predetermined criteria, behavioral data about the user generated based on an analysis of at least one action by the user represented by the personal data, user-determined criteria, and data about individuals other than the user.

3. (canceled)

4. The method of claim 2, wherein the behavioral data is generated in response to the user being presented with insight data.

5. The method of claim 1, wherein the personal data includes a mixture of different formats of data, including image data, and wherein the analyzing is accomplished using video analysis.

6. The method of claim 1, further comprising the step of presenting the user with one or more recommendations regarding the personal data or insight data, wherein the recommendation includes one or more selected from the group consisting of an action that the user may take, an activity the user may participate in, and an item that the user may acquire.

7. The method of claim 6, wherein the recommendation is directed to achieving one or more selected from the group consisting of enabling more efficient daily routines for the user, enabling the user to enhance the calculated score for the one type of personal data, and enabling the user to achieve goals determined by the user for the one type of personal data.

8. The method of claim 1, wherein the insight data comprises a calculated score relevant to the user that relates to one type of insight data selected from the group consisting of security related data, finance related data, shopping related data, and Internet search related data.

9. The method of claim 1, further comprising the steps of:
enabling the user to share at least a portion of the personal data or insight data with at least one other person;
allowing the other person to provide additional information in response to the personal data shared by the user; and
analyzing the additional information to generate further insight data about the user.

10. The method of claim 9, further comprising the steps of:
capturing another person's behavioral data based on at least one action by that person in response to that other person's personal data or insight data; and
analyzing the other person's behavioral data to generate insight data about the user.

11. A device for managing personal data of a user that is collected from a plurality of information sources and includes event data from a security system, and is analyzed to generate insight data, the apparatus comprising:
a user interface programmed to present the insight data to the user through a user interface in a format that is contextually relevant to the user, the format comprising:
a dashboard through which the user may select to be presented insights from a plurality of types of insight data;
a chronological listing of insight data of the selected type from which the user may select additional data related to at least one insight; and
an insight data screen containing the additional data.

12. The device of claim 11, wherein the format further comprises one or more recommendations regarding the personal data or insight data, wherein the recommendation includes one or more selected from the group consisting of an action that the user may take, an activity the user may participate in, and an item that the user may acquire.

13. The device of claim 12, wherein the recommendation is directed to achieving one or more selected from the group consisting of enabling more efficient daily routines for the user, enabling the user to enhance the calculated score for the one type of personal data, and enabling the user to achieve goals determined by the user for the one type of personal data.

14. The device of claim 11, wherein the format further includes insight data that is a calculated score relevant to the user that relates to one type of insight data selected from the group consisting of security related data, finance related data, shopping related data, and Internet search related data.

15. The device of claim 11, wherein the format further comprises:
a link programmed to enable the user to share at least a portion of the personal data or insight data with at least one other person;
the presentation of further insight data generated from the analysis of additional information provided by the other person in response to the personal data shared by the user.

16. The device of claim 15, wherein the format further comprises the presentation of insight data about the user generated from the analysis of the other person's behavioral data, captured based upon at least one action by the other person in response to that other person's personal data or insight data.
